(19) United States
(12) Patent Application Publication
(10) Pub. No.: US 2021/0039563 A1
(43) Pub. Date: Feb. 11, 2021

(54) MOBILE DEVICE HOLDING SYSTEM FOR A SEAT

(71) Applicants: YASHWANTH THERIYUR YASHWANTH THERIYUR SRINIVASSHARMA, Hindupur (IN); ANIS MOHAMMED SHAIK, Hyderabad (IN); VENKATESH MANDLIK, Bangalore (IN); SURYA KUMAR MARATA, Bangalore (IN)

(72) Inventors: YASHWANTH THERIYUR YASHWANTH THERIYUR SRINIVASSHARMA, Hindupur (IN); ANIS MOHAMMED SHAIK, Hyderabad (IN); VENKATESH MANDLIK, Bangalore (IN); SURYA KUMAR MARATA, Bangalore (IN)

(21) Appl. No.: 16/531,948

(22) Filed: Aug. 5, 2019

(51) Int. Cl. B60R 11/02; F16M 11/10; F16M 11/28

(52) U.S. Cl. CPC B60R 11/0241; F16M 11/10; B60R 2011/0012; B60R 11/0252; B60R 11/0211; F16M 11/28

(57) ABSTRACT

A mobile device holding system for a vehicle is disclosed. The mobile device holding system includes a seat having a body, where the body of the seat defines an enclosure. The mobile device holding system further includes a mobile device holder moveable between a stowed position and a deployed position. The mobile device holder includes a holder base and a retractable arm. The holder base has one or more retaining members configured to secure a mobile device to the holder base. The holder base is stored within the enclosure of the seat when in the stowed position. The retractable arm defines a first end coupled to the seat and a second end coupled to the holder base. The retractable arm is configured to extend the holder base from the stowed position and into the deployed position to move the holder base out of the enclosure.

### INTRODUCTION

The present disclosure relates to a mobile device holding system for a seat. More particularly, the present disclosure relates to a mobile device holder that is coupled to a seat, where the mobile device holder is moveable between a stowed position and a deployed position.

### BACKGROUND

An inflight entertainment system may be provided to passengers on longer flights. For example, an overseas flight may employ a relatively larger aircraft that provides an inflight entertainment system to passengers. However, shorter flights typically employ smaller aircraft that may not provide inflight entertainment systems, or only provide audio entertainment. Accordingly, passengers may use their own personal mobile devices on shorter flights. Specifically, passengers watch movies, television shows, or visit websites using their personal mobile devices. Some examples of personal mobile devices include, but are not limited to, smartphones and tablet computers.

A passenger typically holds the personal mobile device in his or her hands while viewing the display screen. However, holding the device in one's hands may become inconvenient at times. For example, it is difficult to hold a personal mobile device while eating or drinking. Furthermore, passengers usually need to tilt their head down while viewing the display screen of their personal mobile device, which may become uncomfortable over time or cause fatigue. Accordingly, there is a need for an improved approach that allows users to view their personal mobile devices when seated in an airplane or other vehicle.

### SUMMARY

According to several aspects, a mobile device holding system for a vehicle is disclosed. The mobile device holding system includes a seat having a body, where the body of the seat defines an enclosure, and a mobile device holder moveable between a stowed position and a deployed position. The mobile device holder includes a holder base having one or more retaining members configured to secure a mobile device to the holder base. The holder base is stored within the enclosure of the seat when in the stowed position. The mobile device holder further includes a retractable arm defining a first end coupled to the seat and a second end coupled to the holder base. The retractable arm is configured to extend the holder base from the stowed position and into the deployed position to move the holder base out of the enclosure.

In another aspect, a mobile device holding system for a vehicle is disclosed. The mobile device holding system includes a seat and a mobile device holder moveable between a stowed position and a deployed position. The mobile device holder includes a holder base having one or more retaining members configured to secure a mobile device to the holder base. The holder base is positioned within a field of view of a passenger when the mobile device holder is moved into the deployed position. The mobile device holder also includes a retractable arm defining a first end coupled to the seat and a second end coupled to the holder base. The retractable arm is configured to extend the holder base from the stowed position and into the deployed position.

In still another aspect, a method of deploying a mobile device holder stored within a seat of a vehicle is disclosed. The method includes moving a door from a closed position and into an opened position, wherein the door is operably connected to a body of the seat. The method further includes extending a retractable arm of the mobile device holder from a stowed position and into a deployed position, where a holder base is stored within an enclosure defined by the body of the seat when the mobile device holder is in the stowed position. Finally, the method includes receiving the mobile device in the holder base. The holder base is coupled to the retractable arm and includes one or more retaining features configured to secure the mobile device within the holder base.

The features, functions, and advantages that have been discussed may be achieved independently in various embodiments or may be combined in other embodiments further details of which can be seen with reference to the following description and drawings.

### BRIEF DESCRIPTION OF THE DRAWINGS

The drawings described herein are for illustration purposes only and are not intended to limit the scope of the present disclosure in any way.

FIG. 1 is a rear view of a seat, where the seat includes a mobile device holder that is in a stowed position, according to an exemplary embodiment;

FIG. 2 is a rear view of the seat where the mobile device holder is in a deployed position, according to an exemplary embodiment;

FIG. 3 is a perspective view of the interior cabin of the vehicle, according to an exemplary embodiment;

FIG. 4 is an enlarged view of the mobile device holder and a slot that is disposed within the seat, according to an exemplary embodiment;

FIG. 5 is an alternative embodiment of the mobile device holder shown in FIG. 1, according to an exemplary embodiment;

FIG. 6 illustrates the mobile device holder in the stowed position, according to an exemplary embodiment;

FIG. 7 illustrates the mobile device holder in the deployed position, according to an exemplary embodiment;

FIG. 8 is a side view of the mobile device holder tilted upwards, according to an exemplary embodiment;

FIG. 9 is a top view of the mobile device holder shown in FIG. 8, according to an exemplary embodiment;

FIG. 10 is a perspective view of a mobile device secured by the mobile device holder, according to an exemplary embodiment;

FIG. 11 is a side view of the mobile device holder shown in FIG. 10, according to an exemplary embodiment;

FIG. 12 is a process flow diagram illustrating a method of extending and retracting the disclosed mobile device holder illustrated in FIGS. 1-11, according to an exemplary embodiment;

FIG. 13 illustrates an alternative embodiment of a mobile device holder, where the mobile device holder is coupled to an arm rest of the seat and is in the stowed position, according to an exemplary embodiment;

FIG. 14 is a front view of the seat shown in FIG. 13, according to an exemplary embodiment;

FIG. 15 is a side view of the seat having the mobile device holder in the deployed position, where the mobile device holder is in the deployed position, according to an exemplary embodiment;

FIG. 16 is a front view of the seat shown in FIG. 15, according to an exemplary embodiment; and

FIG. 17 is a process flow diagram illustrating a method of extending the mobile device holder shown in FIGS. 13-16, according to an exemplary embodiment.

### DETAILED DESCRIPTION

A mobile device holding system for a seat is disclosed. The mobile device holding system is configured to secure various types of mobile devices such as, but not limited to, smartphones, tablet computers, handheld gaming consoles, and portable media players. In one embodiment, the seat is located within an interior cabin of a vehicle. In an embodiment, the interior cabin of the vehicle includes a plurality of seats that each include a mobile device holder moveable between a stowed position and a deployed position. The mobile device holder includes a holder base defining one or more retaining members configured to secure a mobile device. The mobile device holder also includes a retractable arm that defines a first end coupled to the seat and a second end coupled to the holder base, where the retractable arm is configured to extend the holder base from the stowed position and into the deployed position.

The holder base is positioned within a field of view of a passenger when the mobile device holder is moved into the deployed position. In one embodiment, the seat has a body defining an enclosure. The holder base is stored within the enclosure of the seat when the mobile device holder is in the stowed position. The retractable arm is configured to extend the holder base from the stowed position and into the deployed position to move the holder base out of the enclosure. Alternatively, in another embodiment, the seat includes an arm rest. The first end of the retractable arm is coupled to the arm rest of the seat. The holder base is disposed underneath the arm rest when the mobile device holder is in the stowed position.

The following description is merely exemplary in nature and is not intended to limit the present disclosure, application, or uses.

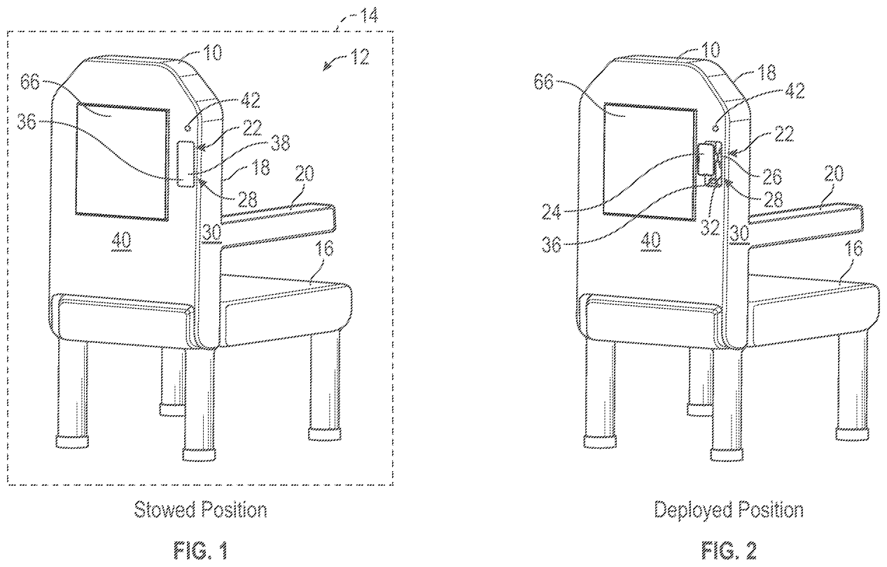

Referring to FIG. 1, a seat 10 located within an interior cabin 12 of a vehicle 14 is illustrated. The seat 10 defines a seat pan 16, a seat back 18, and one or more arm rests 20. The seat 10 includes a mobile device holding system 22. As seen in FIG. 2, the mobile device holding system 22 includes a mobile device holder 28. The mobile device holder 28 is configured to secure a mobile device and includes a holder base 24 and a retractable arm 26. Referring to both FIGS. 1 and 2, the mobile device holder 28 is moveable between a stowed position (FIG. 1) and a deployed position (FIG. 2), where the holder base 24 is accessible by a user when the mobile device holder 28 is in the deployed position.

The seat includes a body 30 defining an enclosure 32 (seen in FIG. 2). The enclosure 32 is sized to accommodate the holder base 24 and the retractable arm 26 when the mobile device holder 28 is in the stowed position. As explained below, the holder base 24 of the mobile device holder 28 is configured to secure a mobile device in place. Therefore, a passenger may not need to hold the mobile device using his or her hands. Accordingly, the passenger's hands remain free to perform other tasks such as eating and drinking. Furthermore, the mobile device holder 28 includes adjustable positioning features. Accordingly, a passenger may adjust the position of the mobile device based on his or her viewing preferences.

The mobile device holding system 22 further includes a door 36 operably connected to the body 30 of the seat 10. The door 36 is moveable between an opened position (seen in FIG. 2) and a closed position (seen in FIG. 1). In the embodiment as shown, the mobile device holder 28 is stored within the enclosure 32 of the seat 10 when in the stowed position. The door 36 restricts access to the holder base 24 and the retractable arm 26 in the closed position. However, the mobile device holder 28 is accessible by a user when the door 36 is in the opened position. Specifically, referring to FIGS. 1, 2, and 3, once the door 36 is moved into the opened position the mobile device holder 28 is accessible by a user.

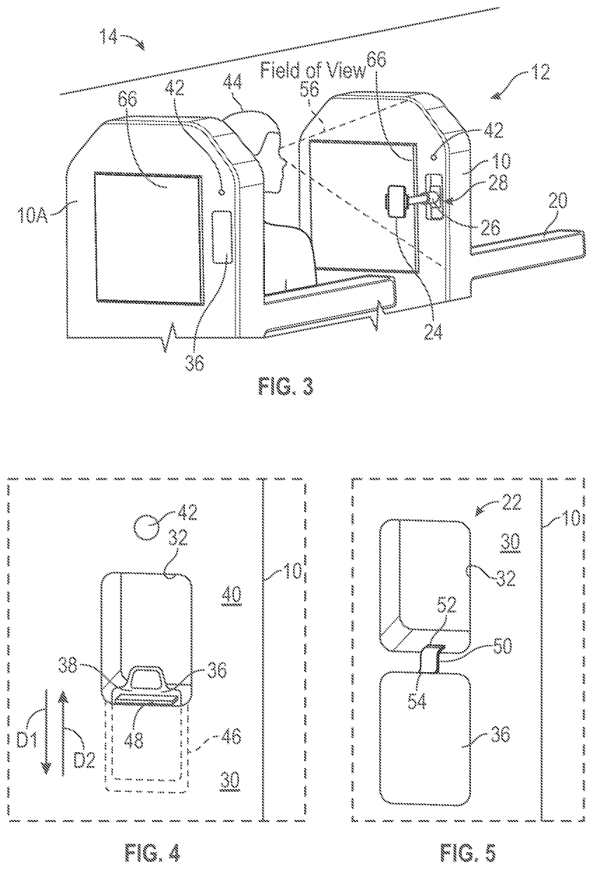

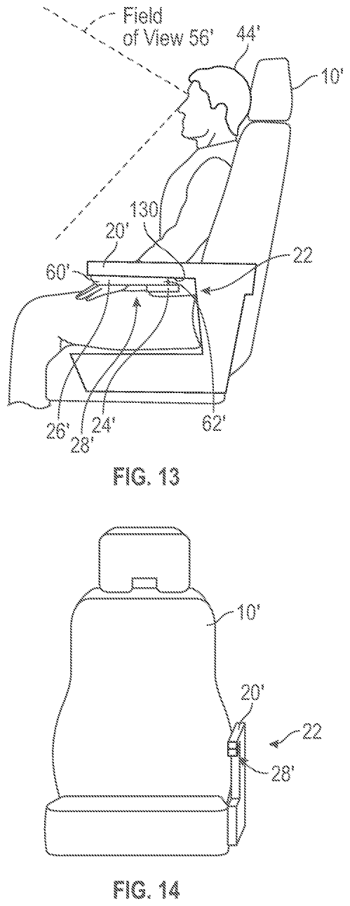

As seen in FIG. 3, the user is an aircraft passenger 44 located in a seat 10A. The seat 10A is located directly behind the seat 10 containing the enclosure 32 that stores the mobile device holder 28. That is, the mobile device holder 28 is employed by an individual who is located directly behind the seat 10. Accordingly, the holder base 24 is positioned within a field of view 56 of the passenger 44 when the mobile device holder 28 is moved into the deployed position. Although FIG. 3 illustrates the mobile device holder 28 employed by the passenger 44 located behind the seat 10, in an alternative embodiment as shown in FIGS. 13-16 a passenger positioned in the seat employs the mobile device holder.

In the embodiment as shown in FIG. 1, the door 36 conceals the holder base 24 and the retractable arm 26 entirely when in the closed position. However, it is to be appreciated that the embodiment shown in FIG. 1 is merely exemplary in nature, and in another embodiment the mobile device holder 28 may not be entirely concealed. Referring specifically to FIG. 1, the door 36 defines an outermost surface 38. In one non-limiting embodiment, the outermost surface 38 of the door 36 is substantially flush with a rearmost surface 40 of the seat 10 when the door 36 is in the closed position. In the embodiment as shown, a tray table 66 is also located along the rearmost surface 40 of the seat 10.

Referring to both FIGS. 1 and 2, the body 30 of the seat 10 defines the seat back 18. The seat back 18 defines the rearmost surface 40 of the seat. As seen in FIG. 2, in one embodiment the enclosure 32 is disposed along the rearmost surface 40 of the seat back 18. Although FIG. 2 illustrates the enclosure 32 disposed along the rearmost surface 40 of the seat 10, it is to be appreciated that the enclosure 32 may be positioned along other area of the seat 10 as well.

FIG. 4 is an enlarged view of the enclosure 32 disposed along the rearmost surface 40 of the seat 10. It is to be appreciated that the holder base 24 and the retractable arm 26 are not illustrated in FIG. 4 for purposes of clarity. Referring to FIGS. 1, 2, and 4, a selection device 42 is disposed along the rearmost surface 40 of the seat 10. The selection device 42 is illustrated as a pushbutton, however other devices such as, for example, a switch may be used as well. The passenger 44 (shown in FIG. 3) manipulates the selection device 42 to actuate the door 36 from the closed position and into the opened position. For example, a user may press the pushbutton to move the door 36 into the opened position.

In one embodiment, the door 36 is moveable in a substantially linear direction. Specifically, the door 36 is moveable in a first linear direction D1 and into a slot 46 (shown in phantom line in FIG. 4). As seen in FIG. 4, the body 30 of the seat 10 defines the slot 46. The door 36 is configured to slide in the first linear direction D1 into the slot 46. The door 36 is also moveable in a second direction D2 that generally opposes the first direction D1. The door 36 is urged out of the slot 46 when a user slides the door 36 in the second direction D2, and back into the closed position as seen in FIG. 1. As seen in FIG. 4, in one non-limiting embodiment the door 36 includes a tab 48. The tab 48 projects outward from the outermost surface 38 of the door 36 and provides a surface that a user may grasp and hold when sliding the door 36 out of the slot 46.

FIG. 5 is an alternative embodiment of the door 36 in the opened position. In the embodiment as shown in FIG. 5, the mobile device holding system 22 includes a compliant strap 50 that connects the door 36 to the body 30 of the seat 10. Specifically, the compliant strap 50 defines a first end 52 and a second end 54. The first end 52 is coupled to the body 30 of the seat 10, and the second end 54 is coupled to the door 36. The compliant strap 50 ensures that the door 36 remains connected to the seat 10 once a user moves the door 36 into the opened position. The compliant strap 50 is constructed of a relatively flexible material such as, for example, rubber.

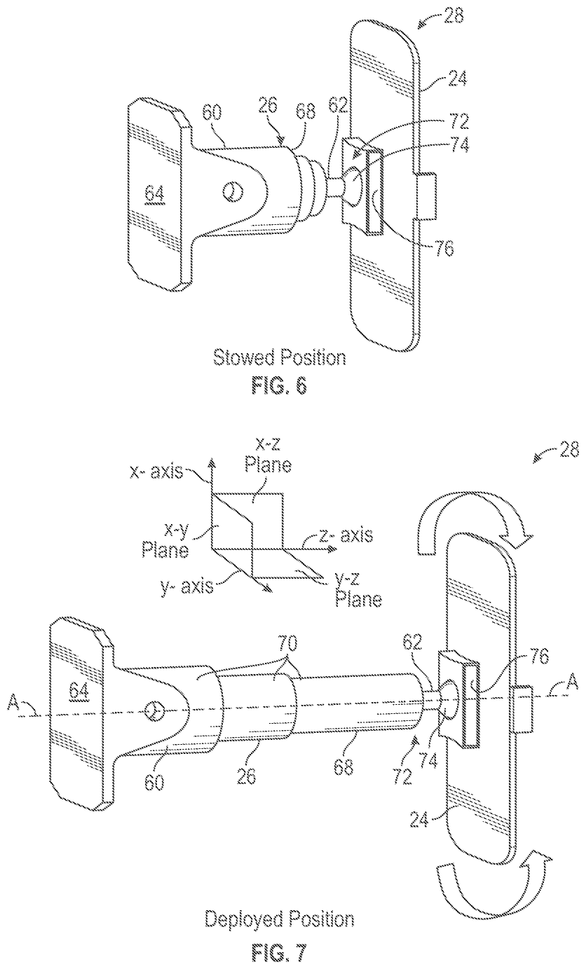

FIG. 6 is an enlarged view of the mobile device holder 28 in the stowed position, and FIG. 7 is an enlarged view of the mobile device holder 28 in the deployed position. Referring to FIGS. 2, 6, and 7, the retractable arm 26 defines a first end 60 coupled to the seat 10 (FIG. 2) and a second end 62 coupled to the holder base 24, where the retractable arm 26 is configured to extend the holder base 24 from the stowed position and into the deployed position to move the holder base 24 out of the enclosure 32 (FIG. 2). In the embodiment as shown in FIGS. 6 and 7, the first end 60 of the retractable arm 26 is coupled to a base plate 64. In one embodiment, the base plate 64 is fixedly attached to the body 30 of the seat 10. Alternatively, in another embodiment, the first end 60 of the retractable arm 26 is directly connected to the body 30 of the seat 10. In example embodiments, the retractable arm 26 is configured to automatically extend or manually extend. In an embodiment, the retractable arm 26 is spring-loaded by a biasing mechanism (not shown), and therefore a user may not need to manually extend the retractable arm 26 into the deployed position. In the embodiment as shown in FIGS. 6 and 7, the second end 62 is directly connected to the holder base 24.

The retractable arm 26 is any type of device that is configured to extend into the deployed position and retract back into the stowed position of the mobile device holder 28. In the embodiment as shown, the retractable arm 26 is a telescoping shaft 68. Specifically, the telescoping shaft 68 includes a plurality of concentric tubular elements 70 that allow for the telescoping shaft 68 to expand and collapse along a longitudinal axis A-A of the retractable arm 26. Although a telescoping shaft 68 is shown, it is to be appreciated that other devices may be used as well.

The second end 62 of the retractable arm 26 is rotatably connected to the holder base 24. In the example as shown, a ball joint 72 connects the retractable arm 26 to the holder base 24. The ball joint 72 includes a spherical or rounded bearing 74 disposed at the second end 62 of the retractable arm 26. The rounded bearing 74 is received by a socket 76 that is part of the holder base 24. Although FIGS. 6 and 7 illustrate the ball joint 72, it is to be appreciated that other rotatable devices may be used as well to connect the retractable arm 26 to the holder base 24.

Referring specifically to FIG. 7, the mobile device holder 28 defines an x-axis, a y-axis, and a z-axis. The z-axis is substantially parallel with respect to the longitudinal axis A-A of the retractable arm 26. The x-axis and the y-axis define an x-y plane, the y-axis and the z-axis define a y-z plane, and the x-axis and the z-axis define a x-z plane. The holder base 24 is positioned substantially perpendicular to the z-axis of the mobile device holder 28. The ball joint 72 restricts or prevents translational movement in the z-axis direction of the mobile device holder 28. However, the ball joint 72 allows for free rotation in the x-y plane, the y-z plane, and the x-z plane of the mobile device holder 28. Accordingly, the ball joint 72 allows for relative rotation between the between the retractable arm 26 and the holder base 24, while at the same time preventing translational movement relative to the z-axis.

In an embodiment, the holder base 24 is configured to rotate at least ninety degrees relative to the retractable arm 26 with respect to the x-y plane of the mobile device holder 28. In an embodiment, the holder base 24 is configured to rotate in a full revolution (i.e., 360 degrees) relative to the retractable arm 26. Accordingly, the position of the holder base 24 is configured to adjust positions based on the preferences of a user. Specifically, the position of the holder base 24 is adjusted based on the field of view 56 of the passenger 44 (FIG. 3).

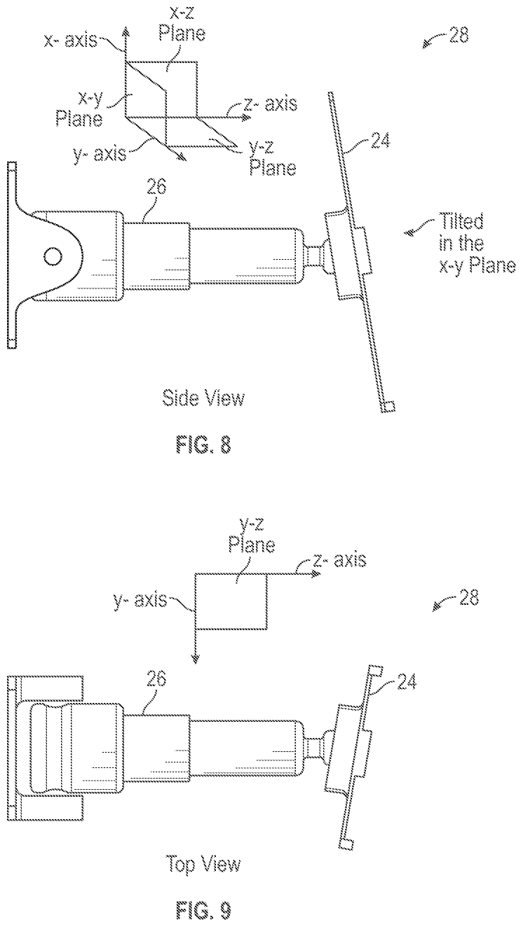

FIG. 8 is a side view of the mobile device holder 28 tilted upwards, where the holder base 24 has been rotated relative to the retractable arm 26 in both the y-z plane and the x-z plane. Referring to FIGS. 3 and 8, the passenger 44 may tilt the holder base 24 upwards based on his or her field of view 56. For example, taller passengers may need to tilt the holder base upwards in order to clearly view the display screen of the mobile device (not shown in FIGS. 8 and 9). FIG. 9 is a top view of the mobile device holder 28 shown in FIG. 8. As seen in FIG. 9, the holder base 24 is further tilted or rotated in the x-z plane as well.

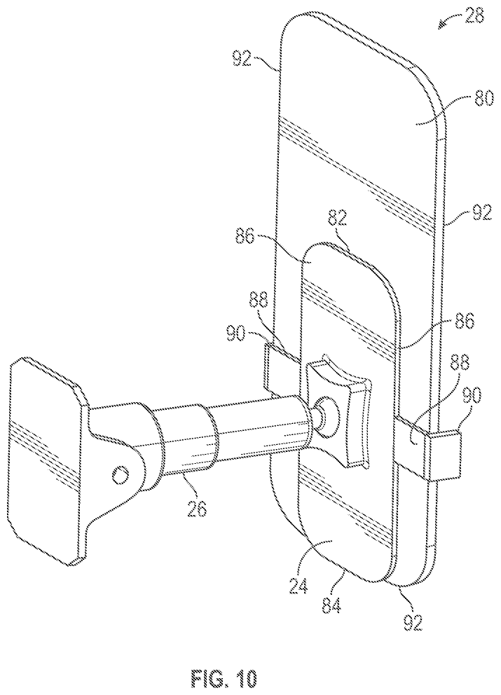

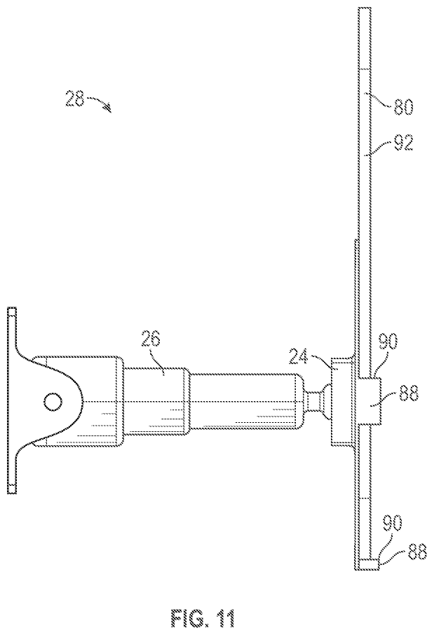

FIG. 10 is a perspective view of the mobile device holder 28 securing a mobile device 80, and FIG. 11 is a side view of the mobile device holder shown in FIG. 10. The mobile device 80 is any type of handheld portable electronic device such as, for example, a smartphone, tablet computer, handheld gaming console, or portable media player. Referring to FIGS. 10 and 11, the holder base 24 of the mobile device holder 28 defines an upper edge 82, a lower edge 84, and opposing side edges 86. In the embodiment as shown, a retaining member 88 is disposed along the lower edge 84 and both of the opposing side edges 86 of the holder base 24. In the non-limiting embodiment as shown in the figures, the retaining members 88 are flanges 90. Each flange 90 is shaped to secure an edge 92 of the mobile device 80. Although FIGS. 10 and 11 illustrate flanges 90, it is to be appreciated that other retaining features may be used as well.

In one embodiment, the mobile device holder 28 includes a charging port (not shown) for providing electrical power to the mobile device 80. If the seat 10 is located upon a vehicle such as an aircraft, then in one embodiment the mobile device 80 is in electronic communication with the aircraft's in-flight entertainment system. The mobile device holder 28 may provide a connection between the mobile device 80 and the in-flight entertainment system. Alternatively, the mobile device 80 is in wireless communication with the in-flight entertainment system.

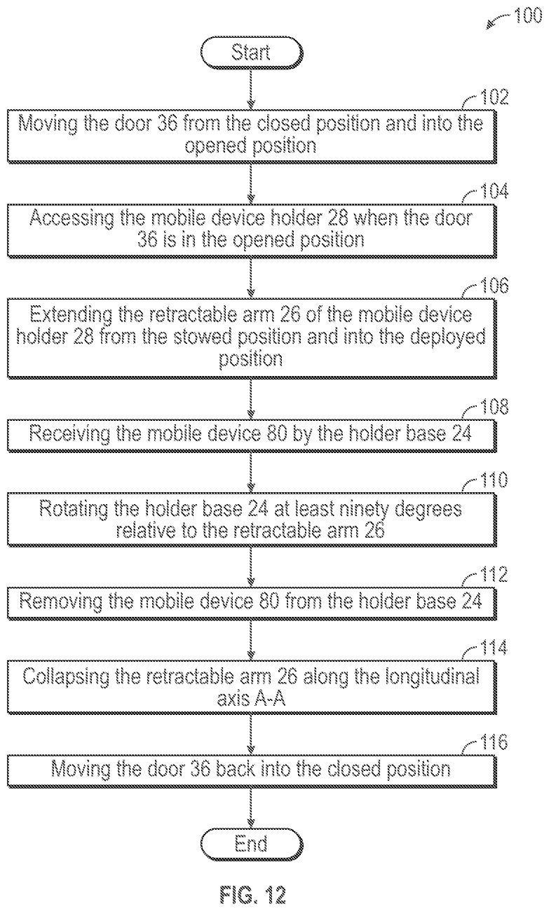

FIG. 12 is an exemplary process flow diagram illustrating a method 100 of deploying and storing the mobile device holder 28 shown in FIGS. 1-11. The mobile device holder 28 is stored within the seat 10 of the vehicle 14. The method 100 begins at block 102. In block 102, a user moves the door 36 from the closed position (FIG. 1) and into the opened position (FIG. 2), where the door 36 is operably connected to the body 30 of the seat 10. Referring specifically to FIG. 3, it is to be appreciated that the user who is opening the door 36 is a passenger located in a seat 10A that is located directly behind the seat 10. The method 100 may then proceed to block 104.

In block 104, the passenger accesses the mobile device holder 28 when the door 36 is in the opened position. The method 100 may then proceed to block 106.

In block 106, the retractable arm 26 of the mobile device holder 28 is extended from the stowed position and into the deployed position. As seen in FIGS. 1 and 2, the holder base 24 is stored within the enclosure 32 defined by the body 30 of the seat 10 when the mobile device holder 28 is in the stowed position. The method 100 may then proceed to block 108.

In block 108, the holder base 24 receives the mobile device 80 (FIGS. 11 and 12). As seen in FIGS. 10 and 11, the holder base 24 is connected to the retractable arm 26 and includes one or more retaining members 88 configured to secure the mobile device 80 within the holder base 24. The method 100 may then proceed to block 110.

In block 110, the holder base 24 is rotated at least ninety degrees relative to the retractable arm 26. In an embodiment, holder base 24 is rotated a full revolution (i.e., 360 degrees) relative to the retractable arm 26. It is to be appreciated that a user may adjust the position of the holder base 24 based on his or her preferences. The method 100 may then proceed to block 112.

In block 112, the mobile device 80 is removed from the holder base 24. The method 100 may then proceed to block 114.

In block 114, the retractable arm 26 is collapsed along the longitudinal axis A-A (seen in FIG. 7), and the retractable arm 26 and the holder base 24 are both placed back into the enclosure 32 within the seat 10 (seen in FIG. 2) and into the stowed position. The method 100 may then proceed to block 116.

In block 116, the door 36 is then moved back into the closed position. The method may then terminate.

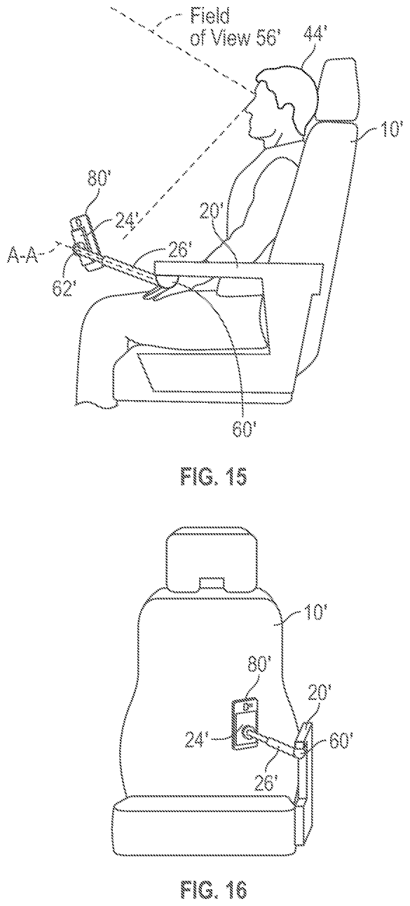

FIGS. 13-16 illustrate yet another embodiment of the mobile device holding system 22. The mobile device holding system 22 of FIGS. 13-16 include mobile device holder 28′ moveable between a stowed position and a deployed position. Specifically, FIGS. 13 and 14 illustrate the mobile device holder 28′ in the stowed position, and FIGS. 15 and 16 illustrate the mobile device holder 28′ in the deployed position. Referring generally to FIGS. 13-16, instead of being stored within the enclosure as seen in FIG. 2, the holder base 24′ and the retractable arm 26′ of the mobile device holder 28′ are positioned underneath the arm rest 20′ of the seat 10′ when in the stowed position. Similar to the holder base 24 and the mobile device holder 28 of FIG. 2, the holder base 24′ is positioned within a field of view of a passenger when the mobile device holder 28′ is moved into the deployed position. It is to be appreciated that unlike the embodiment as shown in FIG. 3, the passenger 44′ is now located within the seat 10′. In other words, the mobile device holder 28′ is employed by the same passenger 44′ who is sitting within the seat 10′.

In the embodiment as shown in FIGS. 13-16, the first end 60′ of the retractable arm 26′ is coupled to the arm rest 20′ of the seat 10′ and the second end 62′ of the retractable arm 26′ is connected to the holder base 24′. Specifically, the first end 60′ of the retractable arm 26′ is rotatably coupled to the arm rest 20′ of the seat 10′. For example, in one embodiment, a hinge or other type of rotatable joint couples the retractable arm 26′ to the arm rest 20′. Referring specifically to FIGS. 13 and 14, when the mobile device holder 28′ is in the stowed position the retractable arm 26′ is located underneath a bottom surface 130 of the arm rest 20′. Moreover, the retractable arm 26′ is substantially aligned with the arm rest 20′ when the mobile device holder 28′ is in the stowed position. Although the mobile device holder 28′ is not completely concealed when in the stowed position, the arm rest 20′ generally blocks the mobile device holder 28′ from the field of view 56′ of the passenger 44′ located within the seat 10′. The holder base 24′ also is disposed underneath the arm rest 20′ when the mobile device holder 28′ is in the stowed position.

Referring now to FIGS. 15 and 16, the retractable arm 26′ is configured to extend the holder base 24′ from the stowed position and into the deployed position. Specifically, the retractable arm 26′ is rotated about the first end 60′ and into the deployed position. When in the deployed position, the retractable arm 26′ is no longer substantially aligned with the arm rest 20′ of the seat 10′. Furthermore, the holder base 24′ is also moved out of the position underneath the arm rest 20′. Instead, as seen in FIG. 16, the holder base 24′ is positioned within the field of view 56′ of the passenger 44′ when the mobile device holder 28′ is moved into the deployed position.

In one embodiment, the retractable arm 26′ is extended along the longitudinal axis A-A, which in turn adjusts the position of the holder base 24′ relative to the field of view 56′ of the passenger 44′. Therefore, the passenger 44′ is able to adjust the holder base 24′ to view the display screen (not visible in FIGS. 15 and 16) of the mobile device 80′. As mentioned above and shown in FIGS. 6 and 7, in one embodiment the retractable arm 26′ is a telescoping shaft having a plurality of concentric tubular elements. The telescoping shaft is configured to expand along the longitudinal axis A-A of the retractable arm 26′ to further adjust the position of the holder base 24′ relative to the field of view 56′ of the passenger 44′.

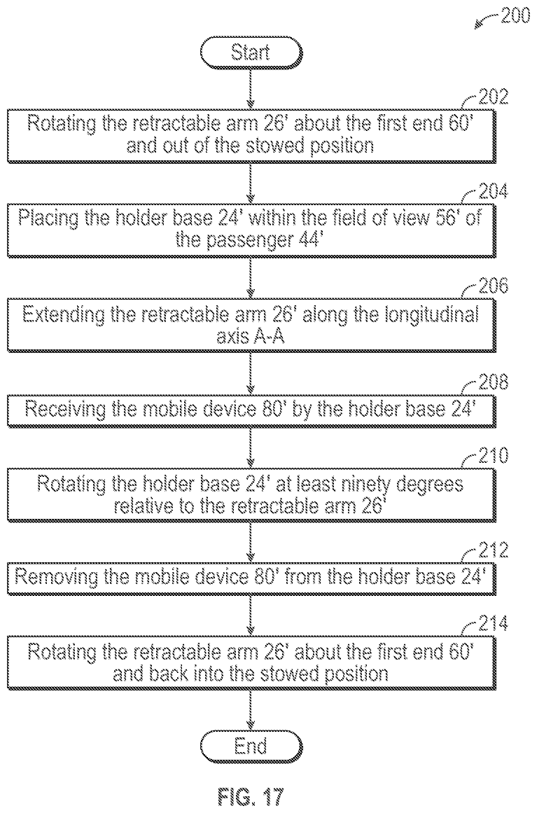

FIG. 17 is an exemplary process flow diagram illustrating a method 200 of deploying the mobile device holder 28′ shown in FIG. 13-16. Referring generally to FIGS. 13-17, the method 200 may begin at block 202. In block 202, the retractable arm 26′ is rotated about the first end 60′ and out of the stowed position. As seen in FIG. 13, when the mobile device holder 28′ is in the stowed position the retractable arm 26′ is located underneath the bottom surface 130 of the arm rest 20′. The method 200 may then proceed to block 204.

In block 204, the holder base 24′ is placed within the field of view 56′ of the passenger 44′ located within the seat 10′, and into the deployed position. The method 200 may then proceed to block 206.

In block 206, the retractable arm 26′ is expanded along the longitudinal axis A-A of to further adjust the position of the holder base 24′ relative to the field of view 56′ of the passenger 44′. The method 200 may then proceed to block 208.

In block 208, the holder base 24′ receives the mobile device 80′ (FIGS. 11 and 12). As seen in FIGS. 10 and 11, the holder base 24′ is connected to the retractable arm 26′ and includes one or more retaining members 88′ configured to secure the mobile device 80′ within the holder base 24′. The method 200 may then proceed to block 210.

In block 210, the holder base 24′ is rotated at least ninety degrees relative to the retractable arm 26′. In an embodiment, holder base 24′ is rotated a full revolution (i.e., 360 degrees) relative to the retractable arm 26′. It is to be appreciated that a user may adjust the position of the holder base 24′ based on his or her preferences. The method 200 may then proceed to block 212.

In block 212, the mobile device 80′ is removed from the holder base 24′ and the retractable arm 26′ is collapsed along the longitudinal axis A-A (seen in FIG. 7). The method 200 may then proceed to block 214.

In block 214, the retractable arm 26′ is rotated about the first end 60′ and back into the stowed position seen in FIG. 14. The method 200 may then terminate.

As described above, in example embodiments the vehicle 14 is an aircraft. However, other example vehicles are also possible. Within examples, the vehicle 14 is a multi-passenger vehicle such as, for example, an aircraft, a train, a bus, or an automobile. Further, although FIG. 1 illustrates the seat 10 located within the interior cabin 12 of the vehicle 14, it is to be appreciated that the seat 10 may be employed in other applications as well and is not limited to a vehicle. For example, in another embodiment the seat 10 is located within a building such as a cinema or theatre. Alternatively, the seat 10 may be located in an outdoor stadium instead.

Referring generally to the figures, the disclosed mobile device holder provides various technical effects and benefits. Specially, the mobile device holder provides a hands-free approach for viewing the display screen of a mobile device. The holder base is rotatable and is adjustable in a variety of positions to accommodate the needs of a passenger, such as an aircraft passenger. Once a passenger is finished viewing the display screen of his or her mobile device, the passenger may then remove the mobile device from the holder base. The mobile device holder is then moved back into the stowed position. In one embodiment, the disclosed mobile device holder may also be connected to an aircraft's in-flight entertainment system as well. The mobile device holder may be especially advantageous for differently-abled individuals who may not be able to hold a mobile device with their hands. Moreover, these individuals may also be able to command the in-flight entertainment system based on voice commands.

By the term “substantially” with reference to characteristics or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A mobile device holding system for a vehicle, comprising:
a seat having a body, wherein the body of the seat defines an enclosure; and
a mobile device holder moveable between a stowed position and a deployed position, the mobile device holder comprising:
a holder base having one or more retaining members configured to secure a mobile device to the holder base, wherein the holder base is stored within the enclosure of the seat when in the stowed position; and
a retractable arm defining a first end coupled to the seat, a second end coupled to the holder base, and a longitudinal axis positioned along a center of the retractable arm that extends from the first end to the second end, wherein the retractable arm is configured to expand along the longitudinal axis to extend the holder base from the stowed position and into the deployed position to move the holder base out of the enclosure and collapse along the longitudinal axis to move the holder base from the deployed position and into the stowed position.

2. The mobile device holding system of claim 1, further comprising a door operably connected to the body of the seat, wherein the door is moveable between an opened position and a closed position.

3. The mobile device holding system of claim 2, wherein the mobile device holder is accessible by a user when the door is in the opened position.

4. The mobile device holding system of claim 2, wherein the door defines an outermost surface, and wherein the outermost surface of the door is substantially flush with a rearmost surface of the seat when the door is in the closed position.

5. The mobile device holding system of claim 2, further including a compliant strap that connects the door to the body of the seat.

6. The mobile device holding system of claim 2, wherein the body of the seat defines a slot, and wherein the door is configured to slide into the slot and into the closed position.

7. The mobile device holding system of claim 1, wherein the holder base is configured to rotate at least ninety degrees relative to the retractable arm.

8. The mobile device holding system of claim 1, wherein the mobile device holder defines an upper edge, a lower edge, and opposing side edges, and wherein a retaining member is disposed along the lower edge and both of the opposing side edges.

9. The mobile device holding system of claim 1, wherein the retractable arm is a telescoping shaft.

10. The mobile device holding system of claim 1, further comprising a ball joint connecting the retractable arm to the mobile device holder.

11. The mobile device holding system of claim 1, wherein the body of the seat defines a seat back having a rearmost surface, and wherein the enclosure is disposed along the rearmost surface of the seat back.

12. A mobile device holding system for a vehicle, the mobile device holding system comprising:
a seat defining an arm rest; and
a mobile device holder moveable between a stowed position and a deployed position, the mobile device holder comprising:
a holder base having one or more retaining members configured to secure a mobile device to the holder base, wherein the holder base is positioned within a field of view of a passenger when the mobile device holder is moved into the deployed position, and wherein the holder base is disposed underneath the arm rest when the mobile device holder is in the stowed position; and
a retractable arm defining a first end coupled to the seat and a second end coupled to the holder base, wherein the retractable arm is configured to extend the holder base from the stowed position and into the deployed position and the first end of the retractable arm is coupled to the arm rest of the seat.

13-18. (canceled)

19. A method of deploying a mobile device holder stored within a seat of a vehicle, the method comprising:
moving a door from a closed position and into an opened position, wherein the door is operably connected to a body of the seat;
extending a retractable arm of the mobile device holder along a longitudinal axis from a stowed position and into a deployed position, wherein a holder base is stored within an enclosure defined by the body of the seat when the mobile device holder is in the stowed position, and wherein the retractable arm defines a first end coupled to the seat and second end coupled to the holder base, and the longitudinal axis is positioned along a center of the retractable arm and extending from the first end to the second end; and
receiving the mobile device in the holder base, wherein the holder base is coupled to the retractable arm and includes one or more retaining features configured to secure the mobile device within the holder base.

20. The method of claim 19, further comprising:
rotating the holder base at least ninety degrees relative to the retractable arm.

21. The mobile device holding system of claim 12, wherein the retractable arm is aligned with the arm rest when the mobile device holder is in the stowed position.

22. The mobile device holding system of claim 12, wherein the retractable arm is a telescoping shaft.

23. The mobile device holding system of claim 22, wherein the retractable arm defines a longitudinal axis positioned along a center of the retractable arm, and wherein the longitudinal axis extends from the first end to the second end of the retractable arm.

24. The mobile device holding system of claim 23, wherein the retractable arm is configured to expand along the longitudinal axis of the retractable arm to further adjust a position of the holder base relative to the field of view of the passenger.

25. The mobile device holding system of claim 12, further comprising a rotatable joint that couples the first end of the retractable arm to the arm rest.

26. The mobile device holding system of claim 12, wherein the mobile device holder is employed by the passenger occupying the seat.
